(19) United States
(12) Patent Application Publication
(10) Pub. No.: US 2026/0159676 A1
(43) Pub. Date: Jun. 11, 2026

(54) THERMOPLASTIC POLYOLEFIN AND MOLDED ARTICLE THEREFROM

(71) Applicant: Dow Global Technologies LLC, Midland, MI (US)

(72) Inventors: Andong Liu, Shanghai (CN); Xiang Geng, Shanghai (CN); Jeffrey C. Munro, Bellaire, TX (US); Russell P. Barry, Schänis (CH); Ming Ming, Shanghai (CN); Takahiko Ohmura, Kanagawa-Ku (JP)

(21) Appl. No.: 18/704,290

(22) PCT Filed: Dec. 8, 2021
(86) PCT No.: PCT/CN2021/136322

§ 371 Date: Apr. 24, 2024

(51) Int. Cl. C08L 23/12; C08K 3/04

(52) U.S. Cl. CPC C08L 23/12; C08K 3/04; C08L 2205/025; C08L 2205/03

(57) ABSTRACT

The present disclosure is directed to an article. In an embodiment, a molded article is provided and includes a crosslink-free polymeric composition. The crosslink-free polymeric composition includes from 65 wt % to 75 wt % of a propylene homopolymer, from 20 wt % to 35 wt % of an impact modifier, and from 0.5 wt % to 5 wt % of a pigment (and optional additive), the propylene homopolymer, the impact modifier, and the pigment (and optional additive) amounting to 100 wt % of the crosslink-free polymeric composition. The impact modifier includes at least two members selected from the group consisting of (i) a random ethylene/C₄-C₈ α-olefin copolymer having a density from 0.85 g/cc to 0.89 g/cc, and a melting point from 45° C. to 65° C. and a melt index from 0.1 g/10 min to 6.0 g/10 min, (ii) an ethylene/octene multi-block copolymer having a density from 0.86 g/cc to 0.89 g/cc, a melting point from 115° C. to 125° C. and (iii) an ethylene/propylene/diene terpolymer (EPDM) having an ethylene content from 65 wt % to 87 wt % and a Mooney viscosity (1+4 at 125° C.) from 16 to 68, and (iv) combinations thereof.

### BACKGROUND

Polyolefin elastomers (POEs), including ethylene/α-olefin copolymers are commonly used as impact modifiers for thermoplastic polyolefin (TPO) compounds. When blended with polypropylene, other additives, and optionally reinforcing fillers (such as talc), POEs can be applied to provide a balance of stiffness, impact toughness, and flow properties to the TPO.

In the automotive market, the requirements for aesthetics (surface quality) in molded TPO parts (automotive interior panels, automotive exterior bumper fascia, etc.) is becoming more stringent as the user experience becomes more demanding, requiring greater durability. A problem arises when molded TPO parts containing polyolefin elastomer (POE), such as ethylene/butene copolymer and ethylene/octene copolymer, is subjected to high aging temperature (greater than 100° C.). At high aging temperature, the POE migrates to the surface of the molded TPO part yielding a host of aesthetic defects, such as tiger stripes, whitening, decreased gloss, stickiness, poor haptics, poor weatherability, poor paint stability, and decreased adhesion with other parts.

The art recognizes the need for molded TPO parts containing POE, and automotive parts in particular, that can withstand heat treatment at high temperatures (greater than 100° C.), with reduced migration of POE to the surface of the molded part.

### SUMMARY

The present disclosure is directed to an article. In an embodiment, a molded article is provided and includes a crosslink-free polymeric composition. The crosslink-free polymeric composition includes from 65 wt % to 75 wt % of a propylene homopolymer, from 20 wt % to 35 wt % of an impact modifier, and from 0.5 wt % to 5 wt % of a pigment, the propylene homopolymer, the impact modifier, the pigment (and optional additive) amounting to 100 wt % of the crosslink-free polymeric composition. The impact modifier includes at least two members selected from the group consisting of (i) a random ethylene/C₄-C₈ α-olefin copolymer having a density from 0.85 g/cc to 0.89 g/cc, a melting point from 45° C. to 65° C., and a melt index from 0.1 g/10 min to 6.0 g/10 min, (ii) an ethylene/octene multi-block copolymer having a density from 0.86 g/cc to 0.89 g/cc, and a melting point from 115° C. to 125° C., and (iii) an ethylene/propylene/diene terpolymer (EPDM) having an ethylene content from 65 wt % to 87 wt % and a Mooney viscosity (1+4 at 125° C.) from 16 to 68, and (iv) combinations thereof.

### BRIEF DESCRIPTION OF THE DRAWINGS

FIG. 1A shows light microscopy images of molded articles CE-1, CE-2, CE-3, IE-1, IE-2, IE-3 after heat treatment at 105° C. for 0 hours. The scale bar is 50 μm.

FIG. 1B shows light microscopy images of molded articles CE-1, CE-2, CE-3, IE-1, IE-2, IE-3 after heat treatment at 105° C. for 120 hours. The scale bar is 50 μm.

FIG. 1C shows light microscopy images of molded articles CE-1, CE-2, CE-3, IE-1, IE-2, IE-3 after heat treatment at 105° C. for 480 hours. The scale bar is 50 μm.

FIG. 2A shows light microscopy images of molded articles CE-2, CE-4, IE-4, IE-5, IE-6, IE-7, IE-8, IE-9 after heat treatment at 105° C. for 0 hours. The scale bar is 50 μm.

FIG. 2B shows light microscopy images of molded articles CE-2, CE-4, IE-4, IE-5, IE-6, IE-7, IE-8, IE-9 after heat treatment at 105° C. for 120 hours. The scale bar is 50 μm.

FIG. 2C shows light microscopy images of molded articles CE-2, CE-4, IE-4, IE-5, IE-6, IE-7, IE-8, IE-9 after heat treatment at 105° C. for 480 hours. The scale bar is 50 μm.

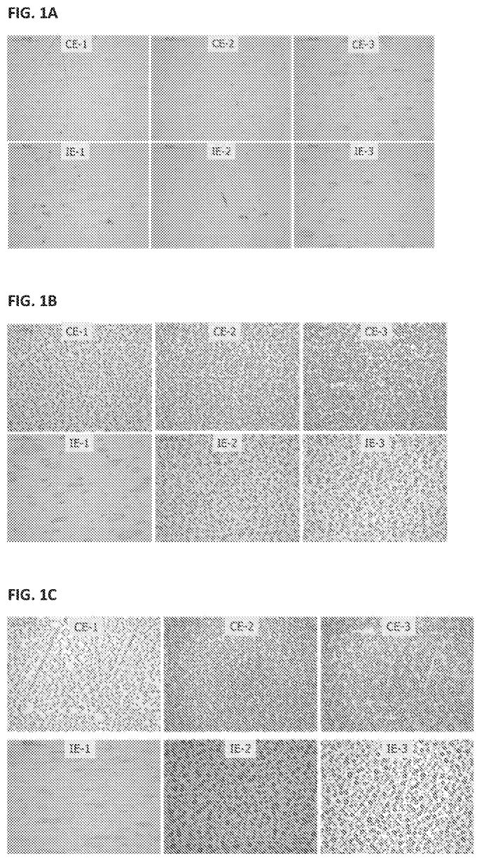

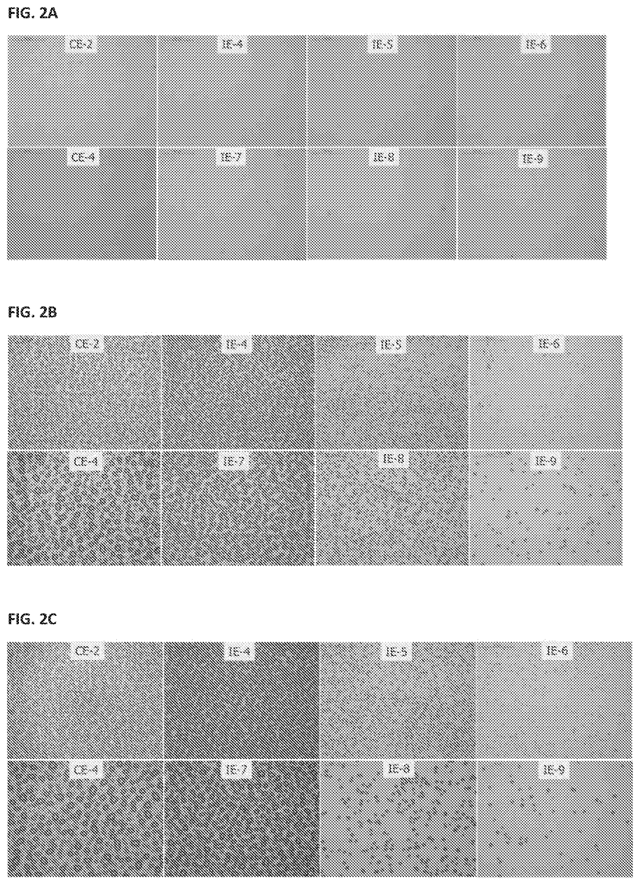

### DEFINITIONS

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Elastomer” and like terms refer to a rubber-like polymer that can be stretched to at least twice its original length and which retracts very rapidly to approximately its original length when the force exerting the stretching is released. An elastomer has an elastic modulus of about 10,000 psi (68.95 MPa) or less and an elongation usually greater than 200% in the uncrosslinked state at room temperature using the method of ASTM D638-72.

An “ethylene-based polymer,” as used herein is a polymer that contains more than 50 weight percent polymerized ethylene monomer (based on the total amount of polymerizable monomers) and, optionally, may contain at least one comonomer.

An “olefin-based polymer,” or “polyolefin,” as used herein is a polymer that contains more than 50 weight percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains more than 50 weight percent polymerized propylene monomer (based on the total amount of polymerizable monomers) and, optionally, may contain at least one comonomer.

### Test Methods

Area ratio of particles. A Python script (available at https://scipy.org/) was developed for the analysis of images of POE particles that migrated to the surface of a TPO plate after thermal treatment. SciPy in Python is an open-source library used for solving mathematical, scientific, engineering, and technical problems. SciPy in Python allows users to manipulate data and visualize data using a wide range of high-level Python commands.

SciPy (available at https://scipy.org/), scikiti-image (available at https://scikit-image.org/), and tkinter libraries were used for the development of the Python script. “Tkinter” is a Python binding the “Tk” (toolkit) to the “GUI” (graphical user interface). Tk is a free and open-source, cross-platform widget toolkit that provides a library of basic elements of GUI widgets for building the GUI. Several functions were applied to get suitable segmentation of the POE particles from the environment (background), including: (i) applying tophat transform to generate a uniform background for thresholding, (ii) a built-in GUI designed to connect the broken POE particle contours on the binary images after thresholding, (iii) morphological reconstruction for creating markers for watershed transform, and (iv) a watershed transform to separate the attached POE particles. The black “tophat” of an image is defined as its morphological closing minus the original image; combined black tophat transform and threshold methods generate clear identification of the particles. The algorithm has a suitable identification and segmentation of the POE particles on TPO plates. The area of the identified particles was measured using regionprops function from scikit-image library. The “regionprops function” measures the properties of labeled image regions, such as area (Number of pixels of the region). The area ratio of particles was calculated as:
sum of the area of the particles identified/the area of the entire image.

Average particle size. A Python script was developed for the analysis of images of POE particles that migrated to the surface of a TPO plate after thermal treatment. SciPy, scikiti-image, and tkinter libraries were used for the development of the script. Several functions were applied to get a suitable segmentation of the POE particles from the environment (background), including: (i) applying tophat transform to generate a uniform background for thresholding, (ii) a built-in GUI designed to connect the broken POE particle contours on the binary images after thresholding, (iii) morphological reconstruction for creating markers for watershed transform, and (iv) a watershed transform to separate the attached POE particles. The algorithm has suitable identification and segmentation of the POE particles on TPO plates. The average particle size was measured by using regionprops function from scikit-image library. The “regionprops function” measures the properties of labeled image regions, such as area (Number of pixels of the region).

The Python script includes the following: distance_transform_edt and binary_fill_holes from ndimage of scipy were used in the script. distance_transform_edt was applied to create the distance map of the binary image. binary_fill_holes was applied to fill the holes in binary objects. scikiti-image was applied to get the binary image by threshold methods, perform segmentation of the binary images, measure the segment images, etc. tkinter was applied for manual correction for any broken contours in the binary images.

Density is measured in accordance with ASTM D792, Method B. The result is recorded in grams (g) per cubic centimeter (g/cc or g/cm3).

Differential Scanning calorimetry (DSC). Differential Scanning calorimetry (DSC) can be used to measure the melting, crystallization, and glass transition behavior of a polymer over a wide range of temperature. For example, the TA Instruments Q1000 DSC, equipped with an RCE (refrigerated cooling system) and an autosampler is used to perform this analysis. During testing, a nitrogen purge gas flow of 50 ml/min is used. Each sample is melt pressed into a thin film at about 175° C.; the melted sample is then air-cooled to room temperature (about 25° C.). A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C. and held isothermal for 3 minutes in order to remove its thermal history. Next, the sample is cooled to −80° C. at a 10° C./minute cooling rate and held isothermal at −80° C. for 3 minutes. The sample is then heated to 180° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature, Tm, and peak crystallization temperature, Tc, heat of fusion, H_{f} (in Joules per gram), glass transition temperature, Tg, and the calculated % crystallinity for polyethylene samples using the following Equation: % Crystallinity=((H_{f})/292 J/g)×100.

The heat of fusion (H_{f}) (also known as melt enthalpy) and the peak melting temperature are reported from the second heat curve.

Melting point, Tm, is determined from the DSC heating curve by first drawing the baseline between the start and end of the melting transition. The peak of the melting endotherm is noted at the melting point, Tm.

Glass transition temperature, Tg, is determined from the DSC heating curve where half the sample has gained the liquid heat capacity as described in Bernhard Wunderlich, The Basis of Thermal Analysis, in Thermal Characterization of Polymeric Materials 92, 278-279 (Edith A. Turi ed., 2d ed. 1997). Baselines are drawn from below and above the glass transition region and extrapolated through the Tg region. The temperature at which the sample heat capacity is half-way between these baselines is the Tg.

Melt flow rate (or MFR) measurement (for the propylene-based elastomers) is performed according to ASTM D1238, Condition 230° C./2.16 kilogram (kg) weight. As with the melt index, the melt flow rate is inversely proportional to the molecular weight of the polymer. Thus, the higher the molecular weight, the lower the melt flow rate, although the relationship is not linear.

Melt index (MI or 12) (for ethylene-based elastomers) is measured in accordance with ASTM D 1238, Condition 190° C./2.16 kg with results reported in grams per 10 minutes (g/10 min).

Mooney viscosity test: EPDM Rubber Mooney Viscosity is measured in a Mooney shearing disk viscometer in accordance with ASTM 1646-04. The instrument is an Alpha Technologies Mooney Viscometer 2000. The torque to turn the rotor at 2 rpm is measured by a torque transducer. The sample is preheated for 1 minute (min) after the platens is closed. The motor is then started and the torque is recorded for a period of 4 min. Results are reported as “ML (1+4) at 125° C.” in Mooney Units (MU). The term “ML” indicates that a large rotor, “Mooney Large,” is used in the viscosity test, where the large rotor is the standard size rotor. Mooney viscosity (MV) measures the resistance of polymer to flow at a relatively low shear rate and indicates the flowability of the polymer.

Tensile strength. The present compositions can be characterized by their tensile strength at break (in MPa) and elongation at break (%). Tensile strength and tensile elongation are measured in accordance with the ASTM D638 testing procedure on compression molded samples prepared according to ASTM D4703. Elongation at break, or elongation to break, is the strain on a sample when it breaks, expressed as a percent.

### DETAILED DESCRIPTION

The present disclosure provides a molded article. In an embodiment, the molded article is composed of a crosslink-free polymeric composition composed of from 65 wt % to 75 wt % of a propylene homopolymer and from 20 wt % to 35 wt % of an impact modifier. The impact modifier is composed of at least two polymeric materials selected from the group consisting of (i) a random ethylene/C₄-C₈ α-olefin copolymer having a density from 0.85 g/cc to 0.89 g/cc, a melting point from 45° C. to 65° C., and a melt index from 0.1 g/10 min to 6.0 g/10 min, (ii) an ethylene/octene multi-block copolymer having a density from 0.86 g/cc to 0.89 g/cc, and a melting point from 115° C. to 125° C., and (iii) an ethylene/propylene/diene terpolymer (EPDM) having an ethylene content from 65 wt % to 87 wt % and a Mooney viscosity (ML (1+4) at 125° C.) from 16 to 68, and (iv) combinations thereof. The polymeric composition also includes from 0.5 wt % to 5 wt % of a pigment (and optional additive).

The molded article is composed of a crosslink-free polymeric composition. A “molded article,” as used herein, is a polymeric composition that is subject to a heat treatment by placing the polymeric composition into a melted state, or otherwise placing the polymeric composition into a pliable state, the melted polymeric composition introduced into a mold to form a molded structure a having a predetermined shape, the cooled molded structure having a thickness from 1 millimeter (mm) to 4 mm. Nonlimiting examples of suitable molded articles include automotive interior panels, automotive bumper fascia, automotive grill components, interior refrigerator panels, and combinations thereof.

The molded article is composed of a crosslink-free polymeric composition composed of from 65 wt % to 75 wt % of a propylene homopolymer and from 20 wt % to 35 wt % of an impact modifier and from 0.5 wt % to 5 wt % pigment (and optional additive). Weight percent is based on total weight of the crosslink-free polymeric composition. The term “crosslink-free polymeric composition,” as used herein, is the polymeric composition that has little, or no, bonds between polymer chains such that gels insoluble in xylene are formed to an extent of from 0%, or from greater than 0% to less than 3 wt % as measured in accordance with ASTM 2765.

The crosslink-free polymeric composition contains from 65 wt % to 75 wt % of a propylene-based polymer. Nonlimiting examples of propylene-based polymer include propylene homopolymer, propylene/α-olefin terpolymer, propylene/α-olefin copolymer, propylene impact copolymer, and combinations thereof. Nonlimiting examples of suitable α-olefins include C₂ and C₄-C₂₀ α-olefins, or C₄-C₁₀ α-olefins, or C₄-C₈ α-olefins. Representative α-olefins include ethylene (propylene/ethylene copolymer), 1-butene (propylene/butene copolymer), 1-pentene (propylene/pentene copolymer), 1-hexene (propylene/hexene copolymer), 1-heptene (propylene/heptene copolymer), and 1-octene (propylene/octene copolymer).

In an embodiment, the crosslink-free polymeric composition includes from 65 wt % to 75 wt % propylene-based polymer that is a propylene homopolymer. The propylene homopolymer has one, some, or all of the following properties;
(i) a density from 0.89 g/cc to 0.91 g/cc, or 0.90 g/cc; and/or
(ii) a MFR from 1.0 g/10 min to 30 g/10 min, or from 10 g/10 min to 28 g/10 min, or from 15 g/10 min to 25 g/10 min; and/or
(iii) a melting point, from 160° C. to 170° C., or from 163° C. to 168° C.

The crosslink-free polymeric composition of the molded article includes from 20 wt % to 35 wt % of an impact modifier. The impact modifier is composed of at least two polymeric materials selected from (i) a random ethylene/C₄-C₈ α-olefin copolymer having a density from 0.85 g/cc to 0.89 g/cc, a melting point from 45° C. to 65° C., and a melt index from 0.1 g/10 min to 6.0 g/10 min, (ii) an ethylene/octene multi-block copolymer having a density from 0.86 g/cc to 0.89 g/cc, a melting point from 115° C. to 125° C. and (iii) an ethylene/propylene/diene terpolymer (EPDM) having an ethylene content for 65 wt % to 87 wt % and a Mooney viscosity (ML (1+4) at 125° C.) from 16 to 68, and (iv) combinations thereof.

The random ethylene/C₄-C₈ α-olefin copolymer is composed of, or otherwise consists of, ethylene and one copolymerizable C₄-C₈ α-olefin comonomer in polymerized form. The C₄-C₈ α-olefin comonomer is selected from butene, hexene, and octene. When present in the impact modifier, the random ethylene/C₄-C₈ α-olefin copolymer has one, some, or all of the following properties:
(i) a density from 0.85 g/cc to 0.89 g/cc, or from 0.86 g/cc to 0.88 g/cc; and/or
(ii) a melting point from 45° C. to 65° C., or from 50° C. to 60° C., and/or
(iii) a melt index from 0.1 g/10 min to 6.0 g/10 min. In an embodiment, the random ethylene/C₄-C₈ α-olefin copolymer has each of the foregoing properties (i)-(iii).

Nonlimiting examples of suitable random ethylene/C₄-C₈ α-olefin copolymer include ENGAGE 8200 and ENGAGE HM7387 available from Dow, Inc.

The term “ethylene/octene multi-block copolymer” refers to an ethylene/octene multi-block copolymer consisting of ethylene and octene comonomer in polymerized form (and optional additives), the polymer characterized by multiple blocks or segments of two polymerized monomer units differing in chemical or physical properties, the blocks joined (or covalently bonded) in a linear manner, that is, a polymer comprising chemically differentiated units which are joined end-to-end with respect to polymerized ethylenic functionality. Ethylene/octene multi-block copolymer includes block copolymer with two blocks (di-block) and more than two blocks (multi-block). The ethylene/octene multi-block copolymer is void of, or otherwise excludes, styrene (i.e., is styrene-free), and/or vinyl aromatic monomer, and/or conjugated diene. When referring to amounts of “ethylene” or “comonomer” in the copolymer, it is understood that this refers to polymerized units thereof. In some embodiments, the ethylene/octene multi-block copolymer can be represented by the following formula: (AB)ₙ; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/octene multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

In an embodiment, ethylene comprises the majority mole fraction of the whole ethylene/octene multi-block copolymer, i.e., ethylene comprises at least 50 wt % of the whole ethylene/octene multi-block copolymer. More preferably, ethylene comprises at least 60 wt %, at least 70 wt %, or at least 80 wt %, with the substantial remainder of the whole ethylene/octene multi-block copolymer comprising the octene comonomer. In an embodiment, the ethylene/octene multi-block copolymer contains 50 wt % to 90 wt % ethylene, or 60 wt % to 85 wt % ethylene, or 65 wt % to 80 wt % ethylene. For many ethylene/octene multi-block copolymers, the composition comprises an ethylene content greater than 80 wt % of the whole ethylene/octene multi-block copolymer and an octene content of from 10 wt % to 15 wt %, or from 15 wt % to 20 wt % of the whole multi-block copolymer.

The ethylene/octene multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers (octene) other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers (octene) other than ethylene) is greater than 5 wt %, or greater than 8 wt %, greater than 10 wt %, or greater than 15 wt %, based on the weight of the polymer. In an embodiment, the comonomer content in the soft segments is greater than 20 wt %, greater than 25 wt %, greater than 30 wt %, greater than 35 wt %, greater than 40 wt %, greater than 45 wt %, greater than 50 wt %, or greater than 60 wt % and can be up to 100 wt %.

The soft segments can be present in an ethylene/octene multi-block copolymer from 1 wt % to 99 wt % of the total weight of the ethylene/octene multi-block copolymer, or from 5 wt % to 95 wt %, from 10 wt % to 90 wt %, from 15 wt % to 85 wt %, from 20 wt % to 80 wt %, from 25 wt % to 75 wt %, from 30 wt % to 70 wt %, from 35 wt % to 65 wt %, from 40 wt % to 60 wt %, or from 45 wt % to 55 wt % of the total weight of the ethylene/octene multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, entitled “Ethylene/α-Olefin Block Inter-Polymers,” filed on Mar. 15, 2006, in the name of Colin L. P. Shan, Lonnie Hazlitt, et. al. and assigned to Dow Global Technologies Inc., the disclosure of which is incorporated by reference herein in its entirety. In particular, hard and soft segment weight percentages and comonomer content may be determined as described in column 57 to column 63 of U.S. Pat. No. 7,608,668.

The ethylene/octene multi-block copolymer comprises two or more chemically distinct regions or segments (referred to as “blocks”) joined (or covalently bonded) in a linear manner, that is, it contains chemically differentiated units which are joined end-to-end with respect to polymerized ethylenic functionality, rather than in pendent or grafted fashion. In an embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/octene multi-block copolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

The ethylene/octene multi-block copolymer (consists only of ethylene and octene comonomer) and has one, some, or all of the following properties:
(i) a Mw/Mn from 1.7, or 1.8 to 2.2, or 2.5, or 3.5; and/or
(ii) a density from 0.850 g/cc to 0.920 g/cc, or from 0.850 g/cc to 0.910 g/cc, or from 0.860 g/cc to 0.890 g/cc, or from 0.860 b/cc to 0.880 g/cc; and/or
(iii) a melting point, Tm, from 115° C. to 125° C., or from 118° C. to 121° C.; and/or
(iv) an MI from 0.7 g/10 min to 20 g/10 min, or from 1.0 g/10 min to 15 g/10 min; and/or
(v) from 50 to 93 wt % soft segment and from 50 to 7 wt % hard segment; and/or
(vi) from 10 mol %, or 13 mol %, or 14 mol %, or 15 mol % to 16 mol %, or 17 mol %, or 18 mol %, or 19 mol %, or 20 mol % C₄-C₁₂ α-olefin in the soft segment; and/or
(vii) from 0.5 mol %, or 1.0 mol %, or 2.0 mol %, or 3.0 mol % to 4.0 mol %, or 5 mol %, or 6 mol %, or 7 mol %, or 9 mol % octene in the hard segment; and/or
(viii) an elastic recovery (Re) from 50%, or 60% to 70%, or 80%, or 90%, at 300%/min deformation rate at 21° C. as measured in accordance with ASTM D 1708; and/or
(ix) a polydisperse distribution of blocks and a polydisperse distribution of block sizes. Ethylene/octene multi-block copolymer with properties (i)-(ix) is disclosed U.S. Pat. No. 7,608,668 the entire contents of which are incorporated by reference herein.

Nonlimiting examples of suitable ethylene/octene multi-block copolymer include INFUSE 9107, INFUSE 9507, and INFUSE 9807 available from Dow Inc.

The ethylene/propylene/diene terpolymer (EPDM) includes a diene. In an embodiment, the diene is an acyclic diene or a cyclic diene. Nonlimiting examples of acyclic dienes include straight chain acyclic dienes, such as 1,4-hexadiene and 1,5-heptadiene; and branched chain acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, and 1,9-deca-diene and mixed isomers of dihydromyrcene. Nonlimiting examples of cyclic dienes include monocyclic dienes such as 1,4-cyclohexadiene, 1,5-cyclooctadiene and 1,5-cyclododecadiene; multi-ring alicyclic fused and bridged ring dienes, such as tetrahydroindene and methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene, and 5-cyclohexylidene-2-norbornene.

In an embodiment, the diene is ENB.

In an embodiment, the EPDM includes only one type of diene. The single type of diene is void, or absent of a heteroatom. In a further embodiment, the EPDM is an ethylene/propylene/5-ethylidene-2-norbornene (ENB) terpolymer. The ethylene/propylene/ENB terpolymer has only three monomers, and the ENB being the sole diene in the terpolymer.

In an embodiment, the EPDM is a neat terpolymer. The term “neat,” as used herein, indicates a material that has no oil within, or upon, its structure. The term “neat,” as used herein, interchangeably indicates a material that is “oil-free.” In an embodiment, the EPDM is a neat EPDM, (i.e., “n-EPDM”).

In an embodiment, the EPDM is an n-EPDM and is composed of:
(i) from 65 to 87 wt %, or from 67 to 85 wt %, polymerized ethylene,
(ii) from 35 wt % to 13 wt %, or from 33 wt % to 15 wt % polymerized propylene,
(iii) from 0.1 wt % to 5.5 wt % ENB, (wherein the aggregate amount of (i), (ii), (iii) is 100 wt % of the n-EPDM), and the n-EPDM has one, some, or all of the following properties:
(iv) a Mooney viscosity from 16 MU to 68 MU, or from 20 MU to 63 MU, and/or
(v) a density from 0.86 g/cc to 0.92 g/cc, or from 0.87 g/cc to 0.92 g/cc.

Nonlimiting examples of suitable n-EPDM include NORDEL IP 3720P, NORDEL IP 3760P, and NORDEL IP 4820P available from Dow Inc.

The crosslink-free polymeric composition includes from 0.5 wt % to 5 wt %, or from 0.5 wt % to 3.0 wt % of a pigment. Nonlimiting examples of suitable pigment include carbon black, titanium dioxide, iron oxide red, and combinations thereof. In an embodiment, the pigment is in the form of a masterbatch with a polymer carrier resin.

The crosslink-free polymeric composition may include on optional additive. In an embodiment, the additive is present in the crosslink-free polymeric composition and includes, but is not limited to filler (such as talc), antioxidant, ultraviolet absorber, antistatic agent, slip additive, release agent, coefficient of friction (COF) modifier, thermal stabilizer, odor modifier/absorbent, and any combination thereof. When present, the additive is present in an amount from 0.1 wt % to 2.0 wt %, or from 0.1 wt % to 1.0 wt %, or from 0.1 wt % to 0.5 wt % based on the total weight of the crosslink-free polymeric composition.

In an embodiment, TPOs are compounded in a twin screw extruder (such as a Coperion ZSK 18 mm twin screw extruder with a general purpose configuration, for example). The profile temperature was set at a temperature from 190° C. to 210° C., or 200° C. For each formulation, polymer resins were dry blended together at the designed ratio. For the injection molding process, compounded TPOs pellets were injection molded in an injection molding apparatus (such as an FANUC S-2000I B series injection molding machine with 28 mm diameter, for example). The profile temperature was set at a temperature from 200° C. to 210° C., or 204° C. and mold temperature was set at a temperature from 35° C. to 40° C., or 38° C. 10 plates were molded with a size of 240 mm×60 mm×2 mm (length×width×thickness).

In an embodiment, the crosslink-free polymeric composition of the molded article includes from 65 wt % to 75 wt % of a propylene homopolymer. The impact modifier consists of from 5 wt % to 15 wt % of the random ethylene/C₄-C₈ α-olefin copolymer, and from 15 wt % to 25 wt % of the ethylene/octene multi-block copolymer. The crosslink-free polymeric composition also includes from 0.5 wt % to 3 wt % pigment (and optional additive). Weight percent is based on total weight of the crosslink-free polymeric composition. It is understood that the amount of propylene homopolymer, impact modifier, and pigment (and optional additive) are 100 wt % of the crosslink-free polymeric component. The molded article has (i) an area ratio of particles from 0% to 33% after 120 hours (hr) at 105° C. and an average area of particle from 0 microns to 20 microns after 120 hr at 105° C. and/or (ii) an area ratio of particles from 0% to 33% after 480 hr at 105° C. and an average area of particle from 0 microns to 19 microns after 480 hr at 105° C.

In an embodiment, the crosslink-free polymeric composition of the molded article includes from 65 wt % to 75 wt % of a propylene homopolymer. The impact modifier consists of from 15 wt % to 25 wt % of the ethylene/octene multi-block copolymer, and from 5 wt % to 15 wt % of the EPDM. The crosslink-free composition also includes from 0.5 wt % to 3 wt % pigment (and optional additive). Weight percent is based on total weight of the polymeric composition. It is understood that the amount of propylene homopolymer, impact modifier, and pigment (and optional additive) are 100 wt % of the crosslink-free polymeric composition. The molded article has (i) an area ratio of particles from 1% to 46% after 120 hr at 105° C. and an average area of particle from 2 microns to 27 microns after 120 hr at 105° C. and/or (ii) an area ratio of particles from 3% to 51% after 480 hr at 105° C. and an average area of particle from 4 microns to 44 microns after 480 hr at 105° C.

In an embodiment, the crosslink-free polymeric composition of the molded article includes from 65 wt % to 75 wt % of a propylene homopolymer. The impact modifier consists of from 15 wt % to 25 wt % of the random ethylene/C₄-C₈ α-olefin copolymer and from 5 wt % to 15 wt % of the EPDM. The crosslink-free polymeric composition also includes from 0.5 wt % to 3 wt % pigment (and optional additive). Weight percent is based on total weight of the polymeric composition. It is understood that the amount of propylene homopolymer, impact modifier, and pigment (and optional additive) are 100 wt % of the crosslink-free polymeric composition. The molded article has (i) an area ratio of particles from 3% to 48% after 120 hr at 105° C. and an average area of particle from 13 microns to 26 microns after 120 hr at 105° C. and/or (ii) an area ratio of particles from 2% to 53% after 480 hr at 105° C. and an average area of particle from 15 microns to 28 microns after 480 hr at 105° C.

In an embodiment, the molded article is selected from an automotive bumper fascia, an automotive door trim panel, an automotive instrument panel, an automotive exterior closure panel (vertical door panel, lift gate or tail gate panel), a rocker panel, an automotive wheel flare, a pillar trim, an airbag cover, an automotive fender, an automotive hood, an automotive roof panel, and combinations thereof.

By way of example, and not limitation, some embodiments of the present disclosure are described in detail in the following examples.

### EXAMPLES

The raw materials used in the Inventive Examples (“IE”) and Comparative Examples (“CE”) are detailed in Table 1 below.

| | | | | Mooney | | | | |
|---|---|---|---|---|---|---|---|---|
| | | | MI@190° C./ | Viscosity, | | Melting | | |
| Commercial | | | 2.16 kg, | ML 1 + 4 at | Density, | point, | Ethylene, | ENB, |
| name | Material | Supplier | g/10 min | 125° C. | g/cc | ° C. | Mass % | Mass % |
| N-Z30S | Propylene | Maoming | 25^{a} | | 0.90 | 167° C. | | |
| | homopolymer | Petrochemical | | | | | | |
| ENGAGE | Random | Dow Inc | 5 | | 0.870 | 59 | | |
| 8200 | Ethylene/octene | | | | | | | |
| | Copolymer | | | | | | | |
| ENGAGE | Random | Dow Inc | 0.2 | | 0.870 | 50 | | |
| HM7387 | Ethylene/butene | | | | | | | |
| | Copolymer | | | | | | | |
| INFUSE 9107 | Ethylene/octene | Dow Inc | 1 | | 0.866 | 121 | | |
| | Multi-block | | | | | | | |
| | copolymer | | | | | | | |
| INFUSE 9507 | Ethylene/octene | Dow Inc | 5 | | 0.866 | 119 | | |
| | Multi-block | | | | | | | |
| | copolymer | | | | | | | |
| INFUSE 9807 | Ethylene/octene | Dow Inc | 15 | | 0.866 | 118 | | |
| | Multi-block | | | | | | | |
| | copolymer | | | | | | | |
| NORDEL IP | EPDM | Dow Inc. | | 20 | 0.882 | | 69 | 0.5 |
| 3720P | | | | | | | | |
| NORDEL IP | EPDM | Dow Inc | | 63 | 0.872 | | 67 | 2.2 |
| 3760P | | | | | | | | |
| NORDEL IP | EPDM | Dow Inc | | 20 | 0.912 | | 85 | 4.9 |
| 4820P | | | | | | | | |
| Plasblak UN | Pigment | Cabot | 5 | | 1.22 | | | |
| 2014 | Carbon black | | | | | | | |
| | master batch | | | | | | | |
| | containing 50% | | | | | | | |
| | carbon black | | | | | | | |
| Irganox B- | Antioxidant blend | BASF | | | | | | |
| 225 | | | | | | | | |

^{a}melt flow rate was measured at 230° C. and 2.16 kg

Materials from Table 1 were compounded in a Twin Screw Extruder Coperion ZSK 18 mm with a general purpose configuration. The profile temperature was set at 200° C. For each formulation, polymeric materials were dry blended together at the designed ratio. The crosslink-free polymeric compositions formed from the materials of Table 1 are shown in Table 2.

### Fabrication of Molded Articles

The crosslink-free polymeric compositions in Table 2 were injection molded in FANUC S-2000I B series injection molding machine with 28 mm diameter. The injection profile temperature was set at 204° C. and mold temperature was set at 38° C. The injection molding speed was 26 mm/s with screw rotation at 80 RPM. The injection molding condition was fixed for all TPO compounds. Ten molded articles (e.g., molded plates) were made, each plate having the dimensions 240 mm×60 mm×2 mm (length×width×thickness).

Each plate was placed into an oven and hung on a shelf in the oven with clips at 105° C. for pre-determined aging times of 0 hours, 120 hours, and 480 hours.

### Light Microscopy (LM) Measurements

A Zeiss Imager, with a Z1m microscope under bright field mode with reflected light was used to analyze the change in the molded article surface caused by the thermal heating at 105° C. for 0 hours, 120 hours and 480 hours. The LM data is shown in Table 2 as Area ratio of particles, %, (“Area ratio” in Table 2) and Average area of particles, microns, (“Ave area” in Table 2) for thermal heating at 105° C. for 120 hours and for 480 hours.

TABLE 2
Molded Articles from Crosslink-Free Polymeric Compositions

| | CE-1 | CE-2 | CE-3 | CE-4 | IE-1 | IE-2 | IE-3 | IE-4 | IE-5 | IE-6 | IE-7 | IE-8 | IE-9 |
|---|---|---|---|---|---|---|---|---|---|---|---|---|---|
| HPP (N-Z30S) | 67.8 | 67.8 | 67.8 | 67.8 | 67.8 | 67.8 | 67.8 | 67.8 | 67.8 | 67.8 | 67.8 | 67.8 | 67.8 |
| INFUSE 9107 | 30 | | | | 20 | | | | | | | | |
| INFUSE 9507 | | 30 | | | | 20 | | 20 | 20 | 20 | | | |
| INFUSE 9807 | | | 30 | | | | 20 | | | | | | |
| ENGAGE 8200 | | | | 30 | | | | | | | 20 | 20 | 20 |
| ENGAGE 7387 | | | | | 10 | 10 | 10 | | | | | | |
| NORDEL IP 3720P | | | | | | | | 10 | | | 10 | | |
| NORDEL IP 4820P | | | | | | | | | 10 | | | 10 | |
| NORDEL IP 3760P | | | | | | | | | | 10 | | | 10 |
| Plasblak UN2014 | 2 | 2 | 2 | 2 | 2 | 2 | 2 | 2 | 2 | 2 | 2 | 2 | 2 |
| Irganox B-225 | 0.2 | 0.2 | 0.2 | 0.2 | 0.2 | 0.2 | 0.2 | 0.2 | 0.2 | 0.2 | 0.2 | 0.2 | 0.2 |
| 120-hours | | | | | | | | | | | | | |
| Area ratio | 23.5 | 56.2 | 58.6 | 42.7 | 0* | 27.6 | 32.4 | 45.7 | 15.1 | 1.3 | 47.9 | 22.7 | 3 |
| Ave area | 8.2 | 20.7 | 34.5 | 45 | 0* | 13.4 | 19.6 | 26 | 6.5 | 2.9 | 25.3 | 14.2 | 13.4 |
| 480-hours | | | | | | | | | | | | | |
| Area ratio | 28 | 63.7 | 61.2 | 39.3 | 0* | 27.8 | 32.8 | 50.7 | 19.7 | 3.4 | 52.3 | 10.3 | 2.2 |
| Ave area | 11.8 | 31.7 | 36.3 | 50.3 | 0* | 16.1 | 18.3 | 43.2 | 7.5 | 4.2 | 28.0 | 19.9 | 15.7 |

*no particles on the surface can be observed, no particles are detectable by Zeiss Imager and the Python script

For IE-1, IE-2 and IE-3, incorporation of the random ethylene/C₄-C₈ α-olefin copolymer (ENGAGE HM7387) into the ethylene/octene multi-block copolymer (INFUSE 9107/9507/9807) reduces the area ratio of particles and the average area of particles on the surface of molded articles compared with CE-1 (28/11.8 for CE-1 compared to 0/0 for IE-1), CE-2 (63.7/31.7 for CE-2 compared to 27.8/16.1 for IE-2, and CE-3 (62.1/36.3 compared to 32.8/18.3 for IE-3) respectively. Bounded by no particular theory, it is believed the presence of the random ethylene/C₄-C₈ α-olefin copolymer (ENGAGE HM7387) reduces the migration of ethylene/octene multi-block copolymer (INFUSE 9107/9507/9807) particles to the surface of the molded article.

For IE-4, IE-5, and IE-6, incorporation of EPDM with increasing ethylene content and/or increasing Mooney viscosity into the ethylene/octene multi-block copolymer (INFUSE 9507) reduces the area ratio of particles and the average area of particles on the surface of molded articles compared with CE-2 (63.7/31.7 for CE-2 compared to (i) 50.7/43.2 for IE-4, (ii) 19.7/7.5 for IE-5, and (iii) 3.4/4.2 for IE-6). Bounded by no particular theory, the EPDM anchors the ethylene/octene multi-block copolymer (INFUSE 9507) in the molded article, reducing migration of ethylene/octene multi-block copolymer (INFUSE 9507) particles to the molded article surface.

For IE-7, IE-8, and IE-9, incorporation of EPDM with increasing ethylene content and/or Mooney viscosity into the random ethylene/C₄-C₈ α-olefin copolymer (ENGAGE 8200) reduces the area ratio of particles and the average area of particles on the surface of molded articles compared with CE-4 (39.3/50.3 for CE-4 compared to (i) 52.3/28 for IE-7, (ii) 10.3/19.9 for IE-8, and (iii) 2.2/15.7 for IE-9). Bounded by no particular theory, the EPDM anchors random ethylene/C₄-C₈ α-olefin copolymer (ENGAGE 8200) in the molded article, reducing migration of random ethylene/C₄-C₈ α-olefin copolymer (ENGAGE 8200) particles to the molded article surface.

It is specifically intended that the present disclosure not be limited to the embodiments and illustrations contained herein, but include modified forms of those embodiments including portions of the embodiments and combinations of elements of different embodiments as come within the scope of the following claims.

1. A molded article comprising:
a crosslink-free polymeric composition comprising
from 65 wt % to 75 wt % of a propylene homopolymer;
from 20 wt % to 35 wt % of an impact modifier that is at least two members selected from the group consisting of (i) a random ethylene/C₄-C₈ α-olefin copolymer having a density from 0.85 g/cc to 0.89 g/cc, a melting point from 45° C. to 65° C., and a melt index from 0.1 g/10 min to 6.0 g/10 min, (ii) an ethylene/octene multi-block copolymer having a density from 0.86 g/cc to 0.89 g/cc, a melting point from 115° C. to 125° C. and (iii) an ethylene/propylene/diene terpolymer (EPDM) having an ethylene content from 65 wt % to 87 wt % and a Mooney viscosity (1+4 at 125° C.) from 16 to 68, and (iv) combinations thereof; and
from 0.5 wt % to 5 wt % of a pigment.

2. The molded article of claim 1 wherein the crosslink-free polymeric composition comprises
from 65 wt % to 75 wt % of a propylene homopolymer;
the impact modifier consists of from 5 wt % to 15 wt % of the random ethylene/C₄-C₈ α-olefin copolymer, and from 15 wt % to 25 wt % of the ethylene/octene multi-block copolymer;
from 0.5 wt % to 3 wt % pigment; and
the molded article has an area ratio of particles from 0% to 33% and an average area of particle from 0 microns to 20 microns after 480 hours at 105° C.

3. The molded article of claim 1 wherein the crosslink-free polymeric composition comprises
from 65 wt % to 75 wt % of a propylene homopolymer;
the impact modifier consists of from 15 wt % to 25 wt % of the ethylene/octene multi-block copolymer, and from 5 wt % to 15 wt % of the EPDM;
from 0.5 wt % to 3 wt % pigment; and
the molded article has an area ratio of particles from 3% to 51% and an average area of particle from 4 microns to 44 microns after 480 hours at 105° C.

4. The molded article of claim 1 wherein the crosslink-free polymeric composition comprises
from 65 wt % to 75 wt % of a propylene homopolymer;
the impact modifier consists of from 15 wt % to 25 wt % of the random ethylene/C₄-C₈ α-olefin copolymer and from 5 wt % to 15 wt % of the EPDM, and
from 0.5 wt % to 3 wt % pigment; and
the molded article has an area ratio of particles from 2% to 53% and an average area of particle from 15 microns to 28 microns after 480 hours at 105° C.

5. The molded article of claim 1 wherein the pigment is selected from the group consisting of carbon black, titanium oxide, iron oxide red, and combinations thereof.

6. The molded article of claim 1 wherein the molded article is selected from the group consisting of an automotive bumper fascia, an automotive door trim panel, an automotive instrument panel, an automotive exterior closure panel, a rocker panel, an automotive wheel flare, a pillar trim, an airbag cover, an automotive fender, an automotive hood, an automotive roof panel, and combinations thereof.
